(19) United States
(12) Patent Application Publication
(10) Pub. No.: US 2012/0011444 A1
(43) Pub. Date: Jan. 12, 2012

(54) METHODS, SYSTEMS, AND COMPUTER PROGRAM PRODUCTS FOR REFERENCING AN ATTACHMENT IN A COMMUNICATION

(76) Inventor: Robert Paul Morris, Raleigh, NC (US)

(21) Appl. No.: 12/833,016

(22) Filed: Jul. 9, 2010

(51) Int. Cl. G06F 15/16; G06F 3/01

(52) U.S. Cl. 715/738; 709/206; 715/752; 709/204

(57) ABSTRACT

Methods and systems are described for referencing an attachment in a communication. A first node representing a first communicant and a second node representing a second communicant communicate via a first communication including a resource as an attachment and including a shared attachment reference for identifying the resource in a second communication. The attachment reference is associated with the resource stored in a first execution environment of the first node. The first node receives the attachment reference in the second communication. The stored resource is accessed, based on the association, in response to receiving the attachment reference.

### RELATED APPLICATIONS

This application is related to the following commonly owned U.S. patent application, the entire disclosure being incorporated by reference herein: application Ser. No. ______, (Docket No 0155) filed on 2010/07/______, entitled “Methods, Systems, and Program Products for Processing a Request for a Resource in a Communication”.

### BACKGROUND

Sending documents, images, and other resources by email is common. Exchanging files and other resources as attachments to messages sent in emails is relatively easy for network novices as well as experts. Tracking and managing resources exchanged in emails is more complicated. A user can detach attachments and save copies to a file system or other data store. This separates the resources from the email environment in which they were exchanged and are often discussed. A few email clients allow user to search for and/or navigate through attachments.

GOOGLE's GMAIL allows users to access attachments from past emails in a thread or conversation of messages. All the emails are in a “conversation” that includes an original email and a series of replies to the original. The emails in a conversation are combined into one view with links to attachments included the emails to which they were attached. This combined view makes locating emails in a series of related emails easier provided the thread is not particularly long. A combined view of messages in a conversation can become large and unwieldy with links to attachments scattered in various places in the combined view of the emails in the conversation.

Accordingly, there exists a need for methods, systems, and computer program products for referencing an attachment in a communication.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Methods and systems are described for referencing an attachment in a communication. In one aspect, the method includes communicating, by a first node representing a first communicant with a second node representing a second communicant, via a first communication including a resource as an attachment and including an attachment reference for referencing the resource in a second communication. The method further includes binding the attachment reference to the resource stored in a first execution environment of the first node. The method still further includes receiving, by the first node, the attachment reference in the second communication. The method also includes accessing, based on the binding, the stored resource, in response to receiving the attachment reference.

Further, a system for referencing an attachment in a communication is described. The system includes an execution environment including an instruction processing unit configured to process an instruction included in at least one of a com-port component, a content handler component, a content manager component, and an attachment manager component. The system includes the com-port component configured for communicating, by a first node representing a first communicant with a second node representing a second communicant, via a first communication including a resource as an attachment and including an attachment reference for referencing the resource in a second communication. The system further includes the content handler component configured for binding the attachment reference to the resource stored in a first execution environment of the first node. The system still further includes the content manager component configured for receiving, by the first node, the attachment reference in the second communication. The system still further includes the attachment manager component configured for receiving, by the first node, the attachment reference in the second communication.

### BRIEF DESCRIPTION OF THE DRAWINGS

Objects and advantages of the present invention will become apparent to those skilled in the art upon reading this description in conjunction with the accompanying drawings, in which like reference numerals have been used to designate like or analogous elements, and in which:

FIG. 1 is a block diagram illustrating an exemplary hardware device included in and/or otherwise providing an execution environment in which the subject matter may be implemented;

FIG. 2 is a flow diagram illustrating a method for referencing an attachment in a communication according to an aspect of the subject matter described herein;

FIG. 3 is a block diagram illustrating an arrangement of components for referencing an attachment in a communication according to another aspect of the subject matter described herein;

FIG. 4 is a block diagram illustrating an arrangement of components for referencing an attachment in a communication according to another aspect of the subject matter described herein;

FIG. 5 is a network diagram illustrating an exemplary system for referencing an attachment in a communication according to an aspect of the subject matter described herein;

FIG. 6a is a diagram illustrating a user interface presented via a display according to an aspect of the subject matter described herein;

FIG. 6b is a diagram illustrating a user interface presented via a display according to an aspect of the subject matter described herein;

FIG. 6c is a diagram illustrating a user interface presented via a display according to an aspect of the subject matter described herein;

FIG. 7a illustrates an exemplary communication between a first node and a second node according to an aspect of the subject matter described herein; and

FIG. 7b illustrates an exemplary communication between a first node and a second node according to an aspect of the subject matter described herein.

### DETAILED DESCRIPTION

One or more aspects of the disclosure are described with reference to the drawings, wherein like reference numerals are generally utilized to refer to like elements throughout, and wherein the various structures are not necessarily drawn to scale. In the following description, for purposes of explanation, numerous specific details are set forth in order to provide a thorough understanding of one or more aspects of the disclosure. It may be evident, however, to one skilled in the art that one or more aspects of the disclosure may be practiced with a lesser degree of these specific details. In other instances, well-known structures and devices are shown in block diagram form in order to facilitate describing one or more aspects of the disclosure.

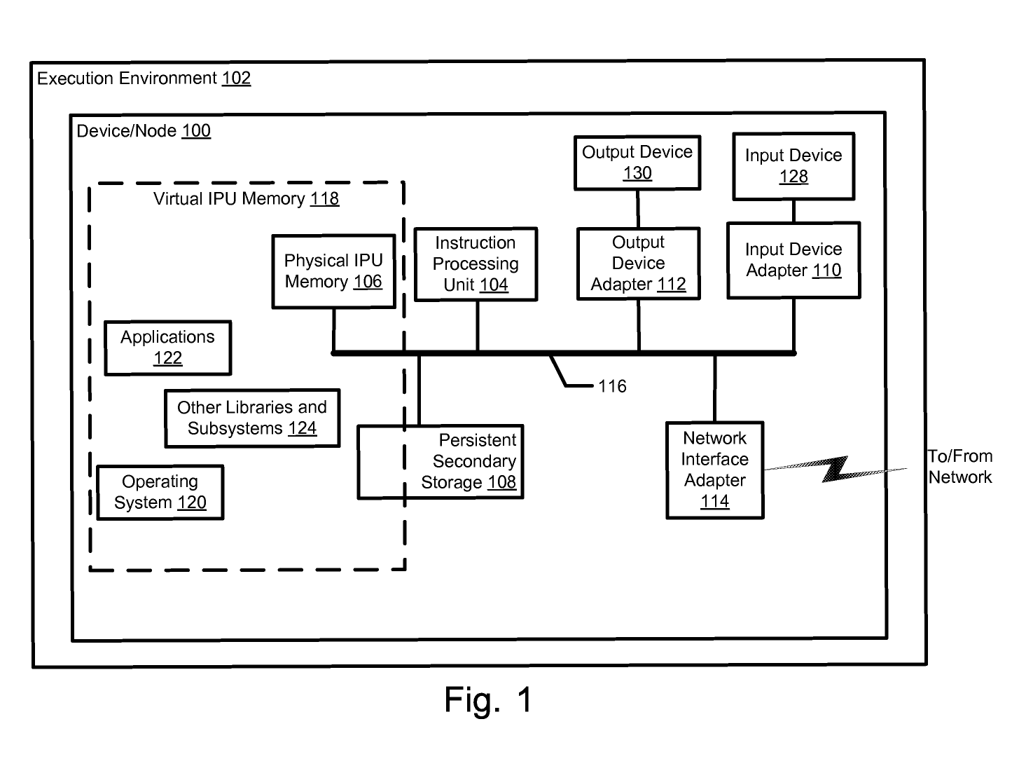

An exemplary device included in an execution environment that may be configured according to the subject matter is illustrated in FIG. 1. An execution environment includes an arrangement of hardware and, optionally, software that may be further configured to include an arrangement of components for performing a method of the subject matter described herein. An execution environment includes and/or is otherwise provided by one or more devices. An execution environment may include a virtual execution environment including software components operating in a host execution environment. Exemplary devices included in or otherwise providing suitable execution environments for configuring according to the subject matter include personal computers, notebook computers, tablet computers, servers, handheld and other mobile devices, multiprocessor devices, distributed devices, consumer electronic devices, routers, communication servers, and/or other network-enabled devices. Those skilled in the art will understand that the components illustrated in FIG. 1 are exemplary and may vary by particular execution environment.

FIG. 1 illustrates hardware device 100 included in execution environment 102. FIG. 1 illustrates that execution environment 102 includes instruction-processing unit (IPU) 104, such as one or more microprocessors; physical processor memory 106 including storage locations identified by addresses in a physical memory address space of IPU 104; persistent secondary storage 108, such as one or more hard drives and/or flash storage media; input device adapter 110, such as a key or keypad hardware, a keyboard adapter, and/or a mouse adapter; output device adapter 112, such as a display or audio adapter for presenting information to a user; a network interface component, illustrated by network interface adapter 114, for communicating via a network such as a LAN and/or WAN; and a communication mechanism that couples elements 104-114, illustrated as bus 116. Elements 104-114 may be operatively coupled by various means. Bus 116 may comprise any type of bus architecture, including a memory bus, a peripheral bus, a local bus, and/or a switching fabric.

IPU 104 is an instruction execution machine, apparatus, or device. Exemplary IPUs include one or more microprocessors, digital signal processors (DSPs), graphics processing units, application-specific integrated circuits (ASICs), and/or field programmable gate arrays (FPGAs). In the description of the subject matter herein, the terms “IPU” and “processor” are used interchangeably. IPU 104 may access machine code instructions and data via one or more memory address spaces in addition to the physical memory address space. A memory address space includes addresses identifying locations in a processor memory. The addresses in a memory address space are included in defining a processor memory. IPU 104 may have more than one processor memory. Thus, IPU 104 may have more than one memory address space. IPU 104 may access a location in a processor memory by processing an address identifying the location. The processed address may be in an operand of a machine code instruction and/or may be identified in a register or other portion of IPU 104.

FIG. 1 illustrates virtual processor memory 118 spanning at least part of physical processor memory 106 and at least part of persistent secondary storage 108. Virtual memory addresses in a memory address space may be mapped to physical memory addresses identifying locations in physical processor memory 106. An address space for identifying locations in a virtual processor memory is referred to as a virtual memory address space; its addresses are referred to as virtual memory addresses; and its processor memory is known as a virtual processor memory or virtual memory. The term “processor memory” may refer to physical processor memory 106 and/or virtual processor memory 118 depending on the context in which the term is used.

Physical processor memory 106 may include various types of memory technologies. Exemplary memory technologies include static random access memory (SRAM) and/or dynamic RAM (DRAM) including variants such as dual data rate synchronous DRAM (DDR SDRAM), error correcting code synchronous DRAM (ECC SDRAM), and/or RAMBUS DRAM (RDRAM). Physical processor memory 106 may include volatile memory as illustrated in the previous sentence and/or may include nonvolatile memory such as nonvolatile flash RAM (NVRAM) and/or ROM.

Persistent secondary storage 108 may include one or more flash memory storage devices, one or more hard disk drives, one or more magnetic disk drives, and/or one or more optical disk drives. Persistent secondary storage 108 may include removable media. The drives and their associated computer-readable storage media provide volatile and/or nonvolatile storage for computer-readable instructions, data structures, program components, and other data for execution environment 102.

Execution environment 102 may include software components stored in persistent secondary storage 108, in remote storage accessible via a network, and/or in a processor memory. FIG. 1 illustrates execution environment 102 including operating system 120, one or more applications 122, and other program code and/or data components illustrated by other libraries and subsystems 124. In an aspect, some or all software components may be stored in locations accessible to IPU 104 in a shared memory address space shared by the software components. The software components accessed via the shared memory address space are stored in a shared processor memory defined by the shared memory address space. In another aspect, a first software component may be stored in one or more locations accessed by IPU 104 in a first address space and a second software component may be stored in one or more locations accessed by IPU 104 in a second address space. The first software component is stored in a first processor memory defined by the first address space and the second software component is stored in a second processor memory defined by the second address space.

Software components typically include instructions executed by IPU 104 in a computing context referred to as a “process”. A process may include one or more “threads”. A “thread” includes a sequence of instructions executed by IPU 104 in a computing sub-context of a process. The terms “thread” and “process” may be used interchangeably herein when a process includes only one thread.

Execution environment 102 may receive user-provided information via one or more input devices illustrated by input device 128. Input device 128 provides input information to other components in execution environment 102 via input device adapter 110. Execution environment 102 may include an input device adapter for a keyboard, a touch screen, a microphone, a joystick, a television receiver, a video camera, a still camera, a document scanner, a fax, a phone, a modem, a network interface adapter, and/or a pointing device, to name a few exemplary input devices.

Input device 128 included in execution environment 102 may be included in device 100 as FIG. 1 illustrates or may be external (not shown) to device 100. Execution environment 102 may include one or more internal and/or external input devices. External input devices may be connected to device 100 via corresponding communication interfaces such as a serial port, a parallel port, and/or a universal serial bus (USB) port. Input device adapter 110 receives input and provides a representation to bus 116 to be received by IPU 104, physical processor memory 106, and/or other components included in execution environment 102.

Output device 130 in FIG. 1 exemplifies one or more output devices that may be included in and/or may be external to and operatively coupled to device 100. For example, output device 130 is illustrated connected to bus 116 via output device adapter 112. Output device 130 may be a display device. Exemplary display devices include liquid crystal displays (LCDs), light emitting diode (LED) displays, and projectors. Output device 130 presents output of execution environment 102 to one or more users. In some embodiments, an input device may also include an output device. Examples include a phone, a joystick, and/or a touch screen. In addition to various types of display devices, exemplary output devices include printers, speakers, tactile output devices such as motion producing devices, and other output devices producing sensory information detectable by a user.

A device included in or otherwise providing an execution environment may operate in a networked environment communicating with one or more devices via one or more network interface components. The terms “communication interface component” and “network interface component” are used interchangeably. FIG. 1 illustrates network interface adapter (NIA) 114 as a network interface component included in execution environment 102 to operatively couple device 100 to a network. A network interface component includes a network interface hardware (NIH) component and optionally a software component. The terms “network node” and “node” in this document both refer to a device having a network interface component for operatively coupling the device to a network.

Exemplary network interface components include network interface controller components, network interface cards, network interface adapters, and line cards. A node may include one or more network interface components to interoperate with a wired network and/or a wireless network. Exemplary wireless networks include a BLUETOOTH network, a wireless 802.11 network, and/or a wireless telephony network (e.g., a cellular, PCS, CDMA, and/or GSM network). Exemplary network interface components for wired networks include Ethernet adapters, Token-ring adapters, FDDI adapters, asynchronous transfer mode (ATM) adapters, and modems of various types. Exemplary wired and/or wireless networks include various types of LANs, WANs, and/or personal area networks (PANs). Exemplary networks also include intranets and internets such as the Internet.

The terms “device” and “node” as used herein refer to one or more devices and nodes, respectively, providing and/or otherwise included in an execution environment unless clearly indicated otherwise.

As used herein, the term “communication” refers to data for sending, sent, and/or received via a network between communicants. A communication includes a message portion addressed to a receiving communicant. A communication is sent to a communicant to present a message in the message portion to the communicant. The term “communicant” as used herein refers to a user represented in a communication. A communicant or user is represented by a “communications agent” configured to operate in an execution environment, on behalf of the represented communicant, to send data to and/or receive data from another communications agent according to a communications protocol via network. A communications protocol defines and/or otherwise identifies an address space including communications addresses for delivering data sent in a communication from one communications agent to another.

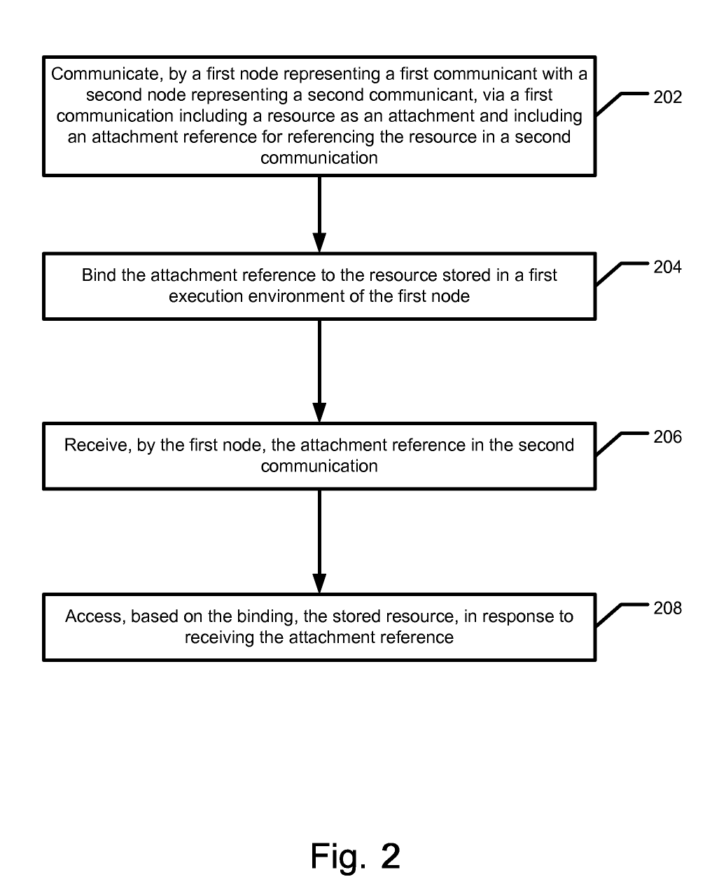

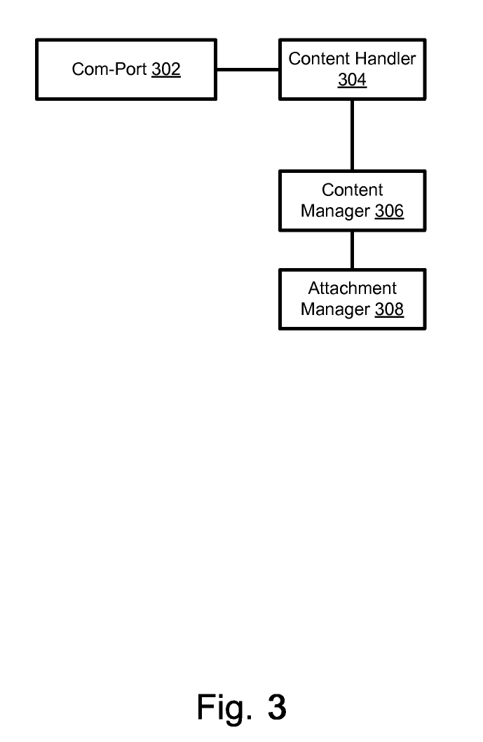

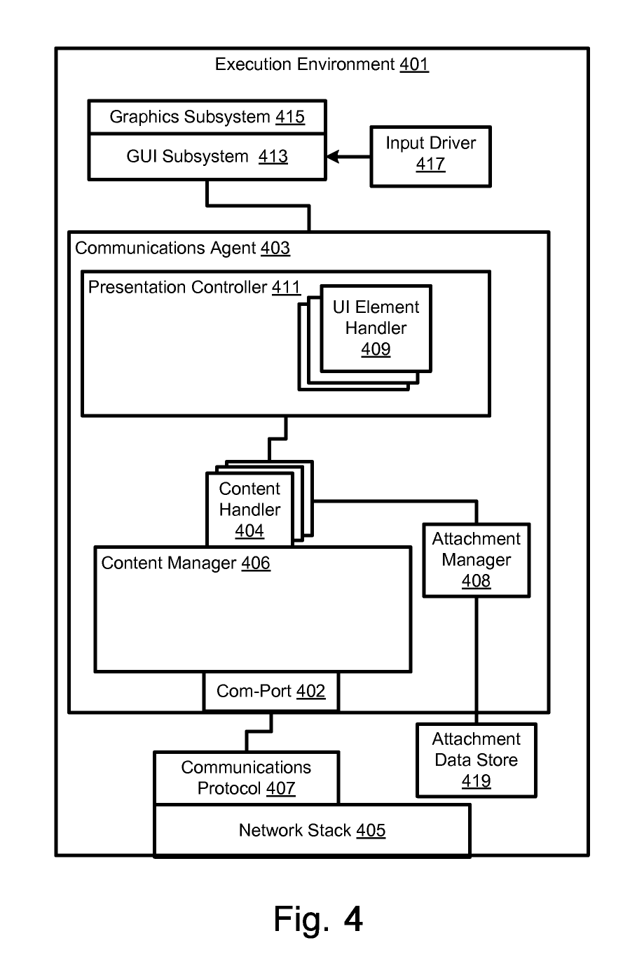

The block diagram in FIG. 3 illustrates an exemplary system for referencing an attachment in a communication according to the method illustrated in FIG. 2. A system for performing the method illustrated in FIG. 2 includes an execution environment, including an instruction-processing unit, configured to process an instruction included in at least one of a com-port component 302, a content handler component 304, a content manager component 306, and an attachment manager component 308 illustrated in FIG. 3. Some or all of the exemplary components illustrated in FIG. 3 may be adapted for performing the method illustrated in FIG. 2 in a number of execution environments. FIG. 4 illustrates a block diagram including the components of FIG. 3 and/or analogs of the components of FIG. 3, respectively, adapted for operation in execution environment 401 including or otherwise provided by one or more nodes.

FIG. 1 illustrates components of an exemplary device that may at least partially provide and/or otherwise be included in an execution environment. The components illustrated in FIG. 4 may be included in or otherwise combined with the components of FIG. 1 to create a variety of arrangements of components according to the subject matter described herein.

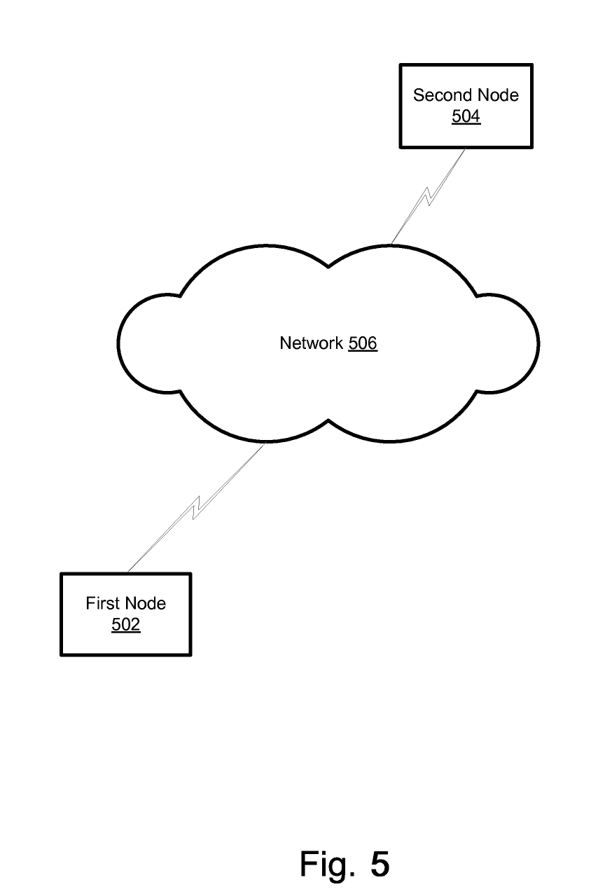

FIG. 5 illustrates first node 502 as an exemplary device included in and/or otherwise adapted for providing an instance and/or adaptation of execution environment 401 in FIG. 4. Second node 504 also illustrates a device that may be included in and/or otherwise adapted for providing an instance and/or adaptation of execution environment 401. FIG. 5 also illustrates that first node 502 and second node 504 are operatively coupled to network 506 via respective network interface components enabling first node 502 and second node 504 to communicate.

Execution environment 401 is illustrated in FIG. 4 hosting communications agent 403. A first instance and/or analog of communications agent 403 may operate in first node 502 and a second instance and/or analog may operate in second node 504. Components in FIG. 4 are referenced for illustrative purposes in describing communications agents operating in an execution environment of first node 502 and an execution environment of second node 504. Exemplary communications agents include email clients, phone clients including Voice over Internet Protocol (VoIP) clients, instant messaging clients, short message service (SMS) clients, multimedia message service (MMS) clients, other multimedia communications clients including video phone clients, and other data transfer agents representing users.

FIG. 4 illustrates communications agent 403 including an adaptation of the arrangement of components in FIG. 3. A first communications agent 403 may operate, in first node 502, on behalf of a first communicant to communicate with a second communicant represented by a communications agent operating in second node 504. Another instance and/or analog of communications agent 403 may operate in an execution environment of second node 504 on behalf of the second communicant.

As stated, the various adaptations of the arrangement in FIG. 3 illustrated and described herein are not exhaustive. For example, those skilled in the art will understand based on the description herein that arrangements of components for performing the method illustrated in FIG. 2 may be distributed across more than one node and/or execution environment. For example, such an arrangement may operate at least partially in a communications agent in a user node, such a first node 502, and at least partially in a server node interoperating with the user node.

FIG. 4 illustrates network stack 405 for sending and/or receiving data in a communication via network 506 in FIG. 5. First node 502 and second node 504 may be operatively coupled to network 506 via respective, network interface components. Network stacks 405 in first node 502 and second node 504 may support the same protocol suite, such as TCP/IP, or may communicate via a network gateway or other protocol translation device and/or service.

Communications agents 403 in FIG. 4, respectively, operating in first node 502 and in second node 504 in FIG. 5 may interoperate via their respective network stacks 405. Communications agents 403 may communicate via one or more communications protocols. FIG. 4 illustrates communications protocol component 407 exemplifying a subsystem for exchanging data via network 506 according to one or more communications protocols, such as simple mail transfer protocol (SMTP), an instant messaging protocol, and/or a real-time voice and/or video protocol such as real-time transport protocol (RTP). A communication between communications agents 403 in first node 502 and second node 504 may include more than one type of data and may use one or more communications protocols for exchanging the one or more types of data via network 506.

Communications agents 403, in FIG. 4, in first node 502 and in second node 504, respectively, may communicate via discrete messages, a request/reply protocol, a data streaming protocol, a session-oriented and/or connection-oriented protocol, a connectionless protocol, a real-time communications protocol, an asynchronous communication, a store and forward communications protocol, a reliable delivery communications protocol, a best-effort delivery communications protocol, a secure protocol and/or an unsecure protocol, to name a few communications options.

FIG. 4 illustrates communications agent 403 including content manager component 406. Content manager component 406 in first node 502 may interoperate with communications protocol layer component 407 and/or network stack 405 to receive data in one or more communications via network 506 with second node 504. Content manager component 406 includes and/or otherwise interoperates with com-port component 402 that operatively couples communications agent 403 to an interface of communications protocol component 407 for sending data to and/or receiving data from second node 504. Second node 504 may include an adaptation and/or analog of communications agent 403 including an adaptation and/or analog of com-port component 402 for receiving data from and/or sending data to first node 502 in a communication.

Some or all data received in a communication may be included in a message portion, as described above, and/or may be included in one or more attachment portions. A message in the message portion and the one or more attachment portions may include data with corresponding content types that may be different. Exemplary content types include plain text, markup such as hypertext markup language (HTML), audio data, image data, and/or executable data. Executable data may include script instruction(s), byte code, and/or machine code.

In FIG. 4, communications agent 403 includes one or more content handler components 404 to process data received according to its content type. A content type may be identified by a MIME type identifier. Exemplary content handler components 404 include a text/html content handler component for processing HTML representations; an application/xmpp-xml content handler component for processing extensible messaging and presence protocol (XMPP) streams, one or more audio content handler components including and/or configured to retrieve suitable codices; one or more video content handler components for processing video representations of various types; and one or more still image data content handler components for processing various image data content types. Content handler component(s) 404 process received data representations and may provide transformed data from the representations to one or more user interface element handler components 409. Alternatively or additionally a content handler component 404 may provide transformed data to store in a data store for subsequent access.

User interface element handler components 409 are illustrated in presentation controller component 411 in FIG. 4. Presentation controller component 411 may coordinate operation of UI element handler components 409. Presentation controller component 411 may manage visual, audio, and other types of output for its including application as well as receive and route detected user and other inputs to components and extensions of its including application, communications agent 403. With respect to FIG. 4, a user interface element handler component 409 may be adapted to operate at least partially in a content handler component 404 such as a text/html content handler component and/or a script content handler component. Additionally or alternatively, a user interface element handler component in execution environment 401 may be received in a communication. For example, an email may include one or more script instructions.

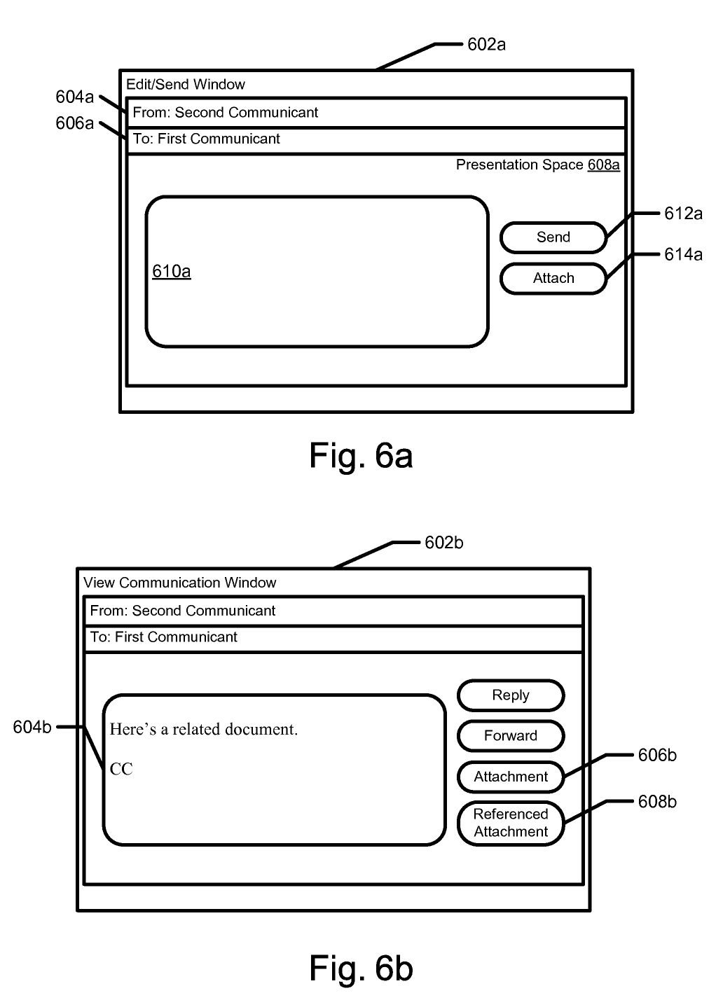

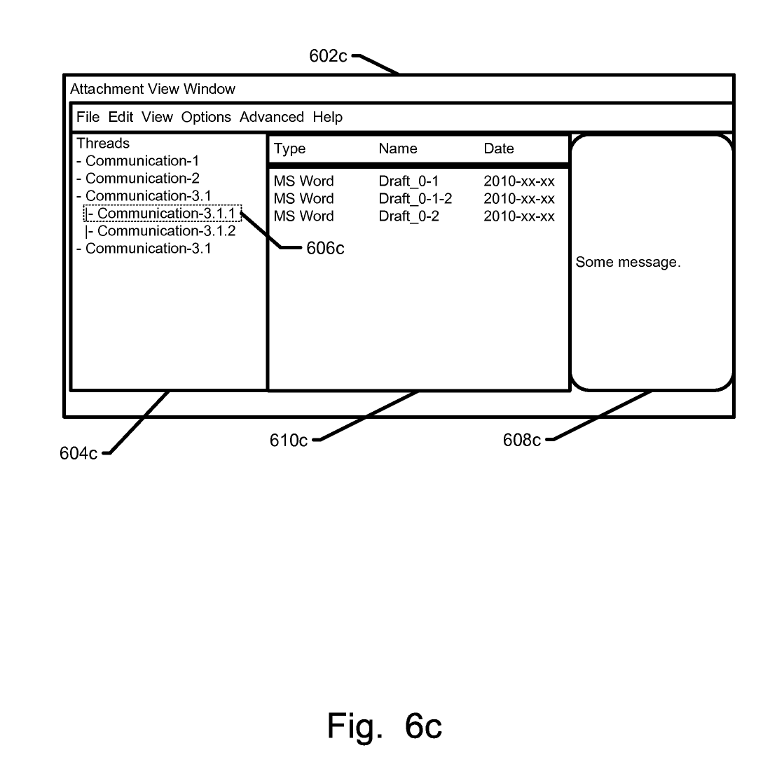

FIG. 6a illustrates an exemplary edit/send window 602a that may be presented, by communications agent 403, in a presentation space of a display device, such as output device 130 in FIG. 1. Edit/send window 602a includes a from-communicant UI element 604a for presenting a communicant identifier of a communicant. The communicant is represented by communications agent 403 presenting edit/send window 602a. Edit/send window 602a also includes to-communicant UI element 606a for presenting one or more communicant identifier(s) identifying one or more communicant(s) addressed in the communication and represented by communications agents operating in other nodes, such as the second communicant represented by second node 504. Presentation space 608a is provided in edit/send window 602a for presenting a message in message UI element 610a. The message is to be sent in the message portion of the communication. Presentation space 608a in FIG. 6a also includes one or more control UI elements for managing the communication. Send UI element 612a illustrates an exemplary control UI element for sending the communication to one or more communicants identified in to-communicant UI element 606a. Attach UI element 614a illustrates an exemplary control for including a resource in the communication as an attachment.

The term “attachment” as used herein refers to a portion of a communication that includes data from one communicant to another other than data in a message portion of the communication. A resource sent as an attachment is data that is typically not presented “inline” or in a message included in a message portion of a communication. Email attachments are perhaps the most widely known attachments included in communications. An email attachment is a file or other resource sent along with a message in an email in a portion of the email separate from a message portion. As defined, other types of text communications as well as voice and video communications may include attachment portions. A communication may include one or more resources as one or more attachments.

The components of a user interface are generically referred to herein as user interface elements. More specifically, visual components of a user interface are referred to herein as visual interface elements. A visual interface element may be a visual component of a graphical user interface (GUI). Exemplary visual interface elements include windows, textboxes, sliders, list boxes, drop-down lists, spinners, various types of menus, toolbars, ribbons, combo boxes, tree views, grid views, navigation tabs, scrollbars, labels, tooltips, text in various fonts, balloons, dialog boxes, and various types of button controls including check boxes and radio buttons. An application interface may include one or more of the exemplary elements listed. Those skilled in the art will understand that this list is not exhaustive. The terms “visual representation”, “visual component”, and “visual interface element” are used interchangeably in this document. Other types of user interface elements include audio output components referred to as audio interface elements, tactile output components referred to as tactile interface elements, and the like.

A “user interface (UI) element handler” component, as the term is used in this document, includes a component configured to send information representing a program entity for presenting a user detectable representation of the program entity by an output device, such as a display. A “program entity” is an object included in and/or otherwise processed by an application or executable program component. The user detectable representation is presented based on the sent information. The sent information is referred to herein as “presentation information”. Presentation information may include data in one or more formats including image formats such as JPEG, video formats such as MP4, markup language data such as HTML and other markup based languages, and/or instructions such as those defined by various script languages, byte code, and/or machine code. For example, a voice communication for receiving by a communications agent and/or for sending by a communications agent may be included in a media container having a specified format, such as MPEG4, and may be compressed, encrypted, and/or otherwise encoded. The data is communicated for presenting in and/or by one or more user interface elements included in a user interface of a communications agent and/or a communications agent. Components configured to send information representing one or more program entities for presenting particular types of output by particular types of output devices include visual interface element handler components, audio interface element handler components, tactile interface element handler components, and the like.

A representation of a program entity may be presented and/or otherwise maintained in a presentation space. As used in this document, the term “presentation space” refers to a storage region allocated and/or otherwise provided for storing presentation information, which may include audio, visual, tactile, and/or other sensory data for presentation by and/or on an output device. For example, a buffer for storing an image and/or text string may be a presentation space. A presentation space may be physically and/or logically contiguous or non-contiguous. A presentation space may have a virtual as well as a physical representation. A presentation space may include a storage location in processor memory; secondary storage; a memory of an output device adapter device; and/or a storage medium of an output device. A screen of a display, for example, is a presentation space.

As used herein, the terms “program”, “program component”, “application”, “application component”, “executable”, and “executable component” refer to any data representation that may be translated into a set of machine code instructions and optional associated program data. Thus, a program or executable may include an application, a shared or non-shared library, and a system command. Program representations other than machine code include object code, byte code, and source code. Object code includes a set of instructions and/or data elements that either are prepared for linking prior to loading or are loaded into an execution environment. When in an execution environment, object code may include references resolved by a linker and/or may include one or more unresolved references. The context in which this term is used will make clear that state of the object code when it is relevant. This definition includes machine code and virtual machine code, such as Java™ byte code.

Various user interface elements that are illustrated in FIG. 6a are presented by one or more user interface (UI) element handler components 409 in presentation controller component 411 in FIG. 4. UI element handler component(s) 409 may send presentation information representing visual interface element(s), such as from-communicant UI element 604a in FIG. 6a, to GUI subsystem 413. GUI subsystem 413 may instruct graphics subsystem 415 to draw the visual interface element(s) in a presentation space of an output device included in execution environment 401 of a node based on the presentation information received in and/or generated from data received in the communication.

Input may be received via input driver 417 in FIG. 4. For example, a user may move a mouse to move a pointer presented in a display of first node 502 over send UI element 612a. The user may provide an input detected by the mouse. The detected input may be received by GUI subsystem 413 via input driver 417 as a send command indicator based on the association of the shared location of the pointer and the send UI element 612a in the presentation space of the display.

Data to send in a communication to a remote communications agent may be received by one or more content handler component(s) 404 to transform the data into one or more representations suitable for transmitting in the communication and/or suitable for processing by the remote communications agent. The one or more data representations may be provided to content manager component 406 to send in the communication. Content manager component 406 may format, encode, and/or otherwise transform the one or more data representations according to a communications protocol supported by communications protocol component 407. Content manager component 406 may alternatively or additionally encode and/or otherwise transform one or more of the data representations for sending in a data stream such as voice stream and/or a video stream for communicating in the communication to the remote communications agent.

Content manager component 406 may provide the transformed data to communications protocol component 407 via com-port component 402. Communications protocol component 407 may further format, encode, and/or otherwise transform the data to send via network stack 405 for delivery via network 506 to a node including a communications agent representing a communicant addressed in the communication.

With reference to FIG. 2, block 202 illustrates that the method includes communicating, by a first node representing a first communicant with a second node representing a second communicant, via a first communication including a resource as an attachment and including an attachment reference for referencing the resource in a second communication. Accordingly, a system for referencing an attachment in a communication includes means for communicating, by a first node representing a first communicant with a second node representing a second communicant, via a first communication including a resource as an attachment and including an attachment reference for referencing the resource in a second communication. For example, as illustrated in FIG. 3, com-port component 302 is configured for communicating, by a first node representing a first communicant with a second node representing a second communicant, via a first communication including a resource as an attachment and including an attachment reference for referencing the resource in a second communication. FIG. 4 illustrates com-port component 402 as an adaptation and/or analog of com-port component 302 in FIG. 3. One or more com-port components 402 operate in execution environment 401.

In an aspect, communicating via a communication may include sending the communication. First node 502 may send a communication including a resource as an attachment and including an attachment reference. A first communicant may identify a second communicant to include in a communication. The first communicant may be represented by communications agent 403 operating in execution environment 401 including and/or provided by first node 502. The second communicant may be represented by a communications agent operating in second node 504. For example, an identifier of the first communicant may be received as input from the first communicant. The identifier may be received to initiate and/or otherwise include the second communicant in a communication.

A message addressed to the second communicant may be received based on input from the first communicant. Edit/send window 602a illustrates a user interface element for creating and editing communications. The received message input may be presented in message UI element 610a. The first communicant may identify a resource to include in the communication as an attachment. User input corresponding to attach UI element 614a in FIG. 6a may be detected by presentation controller component 411 and/or a UI element handler component 409 for attach UI element 614a. Communications agent 403 may present a file system navigation dialog to receive user input to locate a file to include in the communication. A resource to include in a communication may be identified in a variety of ways, in various aspects. For example, a resource may be identified in response to a user dragging and dropping a representation of a resource over edit/send window 602a.

A resource identified for including in a communication may be identified by presentation controller component 411 to attachment manager component 408. Attachment manager component 408 may create a copy of the resource in a data store illustrated by attachment data store 419 in FIG. 4. In another aspect, attachment manager component 408 may store a reference to the resource in attachment data store 419. The resource copy may be stored in the communication or a portion of the communication.

Attachment manager component 408 may generate and/or otherwise identify an attachment reference for the resource. In an aspect, an attachment reference or a portion of an attachment reference may be received from a user. A user may provide an identifier that is memorable to the user and/or to the communicant to whom the communication is to be sent. An attachment reference may be associated with a user-friendly alias and/or symbol that may be easy for the user to recognize and/or recall.

The attachment reference may be a shared identifier exchangeable between first node 502 and second node 504 for referencing the resource from a second communication. An attachment reference may reference a location in a data store in an execution environment of a node including the resource. Nodes in a communication may maintain their own copy of a resource identified by a shared attachment reference.

Attachment manager component 408 may provide the attachment reference and optionally an attachment alias to a content handler component 404 based on the content type of the attachment reference and/or based on a content type of the resource or a portion of the resource. As described above, one or more content handler components 404 process data to be sent in a communication and/or portions of the data to generate a representation of the data or representations of portions of the data suitable for including in a communication according to a communications protocol for delivering the communication to a node identified by a communications address of a communicant to receive the communication.

In response to an indication to initiate a communication and/or to otherwise send data in a communication, message data whether voice, text, and/or image data may be sent by communications agent 403 via communications protocol component 407 for delivery to the second communications agent representing the identified second communicant. For example, a user input corresponding to send button 612a in FIG. 6a may be received by presentation controller component 411 via input driver 417 and GUI subsystem 413 as described above. Presentation controller 411 may provide one or more portions of data to send in the communication to one or more content handlers 404 according to the content types of the data in the one or more portions. For example, a text message may be provided to a text/plain content handler 404 for processing content types having text/plain and/or text/* MIME type identifiers.

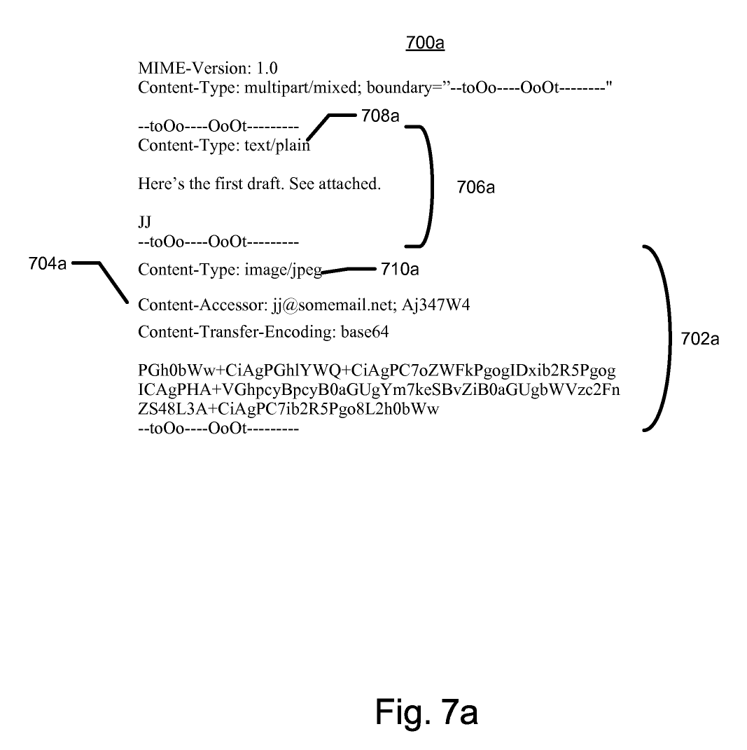

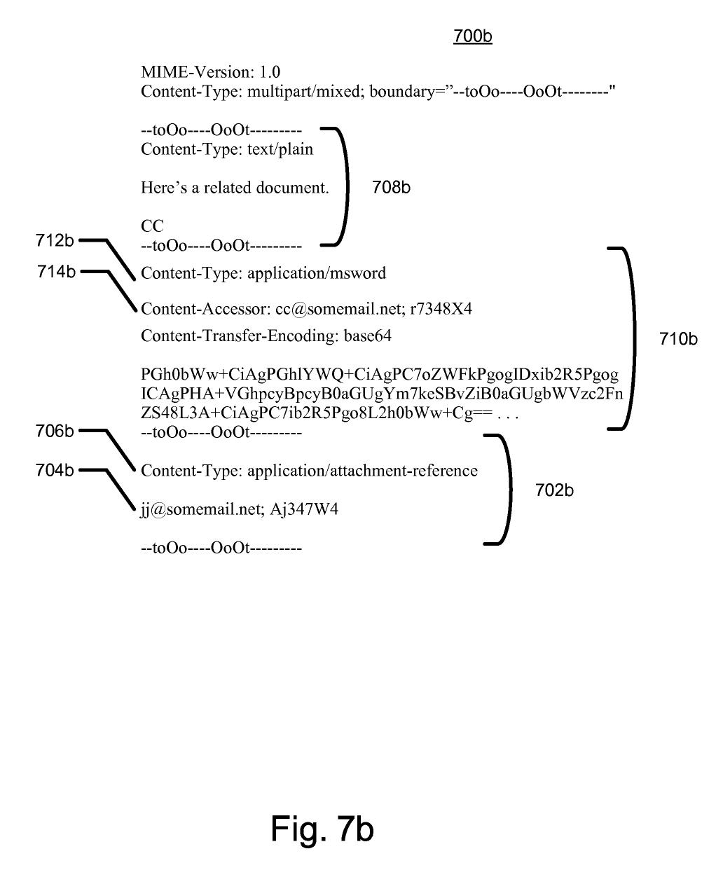

FIG. 7a illustrates email communication 700a. Email communication 700a is illustrated formatted as multipart/mixed content including attachment portion 702a. Attachment portion 702a illustrates content-accessor entity header 704a including “jj@somemail.net; Aj347W4” as an attachment reference. FIG. 7a illustrates message portion 706a including a message addressed to the second communicant.

In another aspect, an attachment reference may be included in a portion separate from a corresponding attachment portion. The attachment reference portion may be identified as including an attachment reference based on, for example, its location in a communication and/or based on a content type identifier for the attachment reference portion.

Content manager component 406, as described above, may provide the communication and/or one or more data representations to include in the communication to com-port component 402. Com-port component 402 may communicate with second node 504 via the communication by sending the communication including the resource and including the attachment reference via network 506 for delivery to second node 504. Com-port component 402 may send the communication by interoperating with communications protocol component 407 to transmit the communication via network stack 405 for delivery to second node 504.

In another aspect, a node may communicate via a communication by receiving the communication via a network from another node. First node 502 may receive a communication via network 506 from second node 504. A resource, such as a document, may be included as an attachment in the communication. The communication may include a message addressed to a first communicant represented by first node 502. The communication also includes an attachment reference for the attached resource.

Com-port component 402 operating in execution environment 401 included in and/or provided by first node 502 may receive a communication including a resource as an attachment and including an attachment reference via network 506 from second node 504. The communication may be received in one or more packets via network stack 405 and communications protocol component 407. Com-port component 402 may provide the data to content manager component 406. Content manager component 406 may determine one or more content types of the data. The content and/or portions of the content may be provided to one or more content handler components 404 based on the one or more content types. For example, FIG. 7a illustrates message portion 706a including “text/plain” MIME type identifier 708a as a content type identifier. The message in message portion 706a may be provided to a text/plain content handler 404. Audio data in a voice communication may be provided to an audio content handler component 404, and video data in a video communication may be provided to a video content handler component 404.

Content manager component 406 may detect content type information described above to detect an attachment portion of a communication. For example, the content illustrated in FIG. 7a may be received in a communication. Content manager component 406 may detect message portion 706a and content type entity header 708a identifying the content type of the data in message portion 706a by “text/plain” MIME type identifier. An “image/jpeg” MIME type identifier in content type entity header 710a identifies the data in attachment portion 702a as image data represented according to a JPEG specification. Content manager component 406 may identify attachment portion 702a based on its location in communication 700a and/or based on its content type.

Content manager component 406 and/or a content handler component 404 compatible with the content type of attachment portion 702a may identify content-accessor entity header 704a as including attachment reference “jj@somemail.net; Aj347W4”.

Returning to FIG. 2, block 204 illustrates that the method further includes binding the attachment reference to the resource stored in a first execution environment of the first node. Accordingly, a system for referencing an attachment in a communication includes means for binding the attachment reference to the resource stored in a first execution environment of the first node. For example, as illustrated in FIG. 3, content handler component 304 is configured for binding the attachment reference to the resource stored in a first execution environment of the first node. FIG. 4 illustrates content handler component 404 as an adaptation and/or analog of content handler component 304 in FIG. 3. One or more content handler components 404 operate in execution environment 401.

An attachment reference may be associated with and/or otherwise bound to a resource received in an attachment in various ways. In an aspect, a record may be created that identifies the attachment reference and identifies access information for accessing the resource from a data store. Whether communications agent 403 in first node 502 sends a communication including an attachment or receives a communication including an attachment, the communication or portions of the communication may be stored in a data store in and/or otherwise accessible to execution environment 401. For example, text/plain content handler component 404 may transform a representation of the message in message portion 706a into a storable representation and provide the storable representation to a message manager (not shown) to store in a data store, such as attachment data store 419 and/or a data storage medium including and/or included in attachment data store 419. An “image/jpeg” content handler component 404 may provide a storage representation of the resource in attachment portion 702a to attachment manager component 408 to store in attachment data store 419. Attachment manager component 408 may receive the attachment reference from the content handler component and store the attachment reference with the storage representation of the resource in addition to or instead of creating a record binding the attachment reference with the resource.

Note that while, in an aspect, a communication and/or a message in the communication may be identified based on an attachment reference in the communication, a resource in the communication may be located based on the attachment reference without locating the message and/or other portions of the communication in which the resource was sent and/or received as an attachment.

An attachment alias may also be stored. An attachment alias may be stored so that the attachment reference for the attachment alias may be located based on the attachment alias. The attachment alias may be easier for a communicant to remember and/or otherwise manage. Analogously, an attachment reference may be stored so that an attachment alias for the attachment reference may be located based on the attachment reference and/or vice versa. The resource bound to the attachment reference may be located based on the attachment reference.

Returning to FIG. 2, block 206 illustrates that the method yet further includes receiving, by the first node, the attachment reference in the second communication. Accordingly, a system for referencing an attachment in a communication includes means for receiving, by the first node, the attachment reference in the second communication. For example, as illustrated in FIG. 3, content manager component 306 is configured for receiving, by the first node, the attachment reference in the second communication. FIG. 4 illustrates content manager component 406 as an adaptation and/or analog of content manager component 306 in FIG. 3. One or more content manager components 406 operate in execution environment 401.

Whether a node is a sender of a communication including a resource as an attachment and an attachment reference or a receiver of the communication, the node may receive a second communication including the attachment reference. First node 502 may receive a second communication including an attachment reference for a resource communicated in a first communication. First node 502 may receive the second communication before, during, and/or after the first communication is communicated. When the second communication is received before the first communication, the attachment reference is predetermined prior to communicating the resource as an attachment. The first and second communicants may exchange information referencing the resource before the resource is communicated.

FIG. 7b illustrates second communication 700b including attachment reference portion 702b identifying the attachment reference “jj@somemail.net; Aj347W4” as content 704b having an “application/attachment-reference” MIME type identifier identifying the content type in content type entity header 706b. Attachment reference “jj@somemail.net; Aj347W4” is the same identifier included in content-accessor entity header 704a in first communication 700a in FIG. 7a. In an aspect, an alias identifying the attachment reference may be included in addition to and/or instead of including the attachment reference.

FIG. 7b also illustrates that second communication 700b includes a message portion 708b, and attachment portion 710b including a resource with a content type identified in content-type entity header 712b by “application/msword” MIME type identifier. FIG. 7b also illustrates attachment portion 710b including an attachment reference “cc@somemail.net; r7348X4” in content-accessor entity header 714b for the resource in attachment portion 710b. Attachment portion 710b, attachment reference “cc@somemail.net; r7348X4”, and the resource represented in attachment portion 710b may be processed as described above.

Returning to FIG. 2, block 208 illustrates that the method yet further includes accessing, based on the binding, the stored resource, in response to receiving the attachment reference. Accordingly, a system for referencing an attachment in a communication includes means for accessing, based on the binding, the stored resource, in response to receiving the attachment reference. For example, as illustrated in FIG. 3, attachment manager component 308 is configured for accessing, based on the binding, the stored resource, in response to receiving the attachment reference. FIG. 4 illustrates attachment manager component 408 as an adaptation and/or analog of attachment manager component 308 in FIG. 3. One or more attachment manager components 408 operate in execution environment 401.

In an aspect, content manager component 406 operating in execution environment 401 including and/or provided by first node 502 may receive the attachment reference in attachment reference portion 702b in second communication 700b. Content manager 406 may provide data in attachment reference portion 702b to a content handler component 404 configured to process data represented according to a schema identified by “application/attachment-reference” MIME type identifier included in content-type entity header 706b in attachment reference portion 702b. The “application/attachment-reference” content handler component 404 in one aspect may automatically access the resource received in first communication 700a in response to receiving the attachment reference in attachment reference portion 702b. The “application/attachment-reference” content handler component 404 may provide the attachment reference to attachment manager component 408. Attachment manager component 408 may locate the resource or a copy of the resource in a data store in execution environment 401, such as the data store illustrated by attachment data store 419. A copy of a resource and the original resource are herein considered equivalents. Either may be referred to the resource.

The “application/attachment-reference” content handler component 404 may generate presentation information to present, via an output device in a UI element in execution environment 401. In another aspect, rather than accessing the resource automatically, “application/attachment-reference” content handler component 404 may provide presentation information for a UI element for receiving a user input for accessing the resource based on the attachment reference. Referenced attachment UI element 608b in FIG. 6b illustrates a UI element for accessing a resource via an attachment reference.

FIG. 6b illustrates view communication window 602b presented by presentation controller component 411 and/or one or more UI element handler components 409 to present a view of the message in message portion 708b in FIG. 7b received in second communication 700b. The view may be presented in message UI element 604b in FIG. 6b. View communication window 602b is illustrated including attachments UI control 606b. In response to detecting a user input corresponding to attachment UI control 606b, presentation controller component 411 and/or one or more UI element handler components 409 may send presentation information to present the resource in attachment portion 710b in second communication 700b in FIG. 7b.

In response to detecting a user input corresponding to referenced attachment UI control 608b, presentation controller component 411 and/or one or more UI element handler components 409 may send the attachment reference received in attachment reference portion 702b to attachment manager component 408 to retrieve the identified resource received in attachment portion 702a in communication 700a in FIG. 7a. Attachment manager component 408 may return the resource to presentation controller component 411, and/or one or more UI element handler components 409 may be instructed to send presentation information to present the resource included in attachment portion 702a in FIG. 7a via an output device. Attachment manager component 408 and/or presentation controller component 411 may provide the resource to one or more suitable content handler components 404 to generate the presentation information for the referenced resource. In an aspect, the resource may be pre-fetched prior to receiving input corresponding to referenced attachment UI control 608b.

FIG. 6c illustrates attachment view window 602c presenting a view of messages received in various communications organized by message thread in thread UI element 604c. A box surrounding a communication identified as communication-3.1.1 606c indicates communication-3.1.1 606c is currently selected. FIG. 6c illustrates message view UI element 608c for presenting a message included in the currently selected communication. Attachment view window 602c includes an attachments UI element 610c for presenting selectable representations of resources communicated in communication-3.1.1 606c and/or identified in communication-3.1.1 606c by attachment references identifying resources included as attachments communicated in other communications. Attachments UI element 610c illustrates 3 versions of a document exchanged in various communications including communication-3.1.1 606c.

The method illustrated in FIG. 2 may include additional aspects supported by various adaptations and/or analogs of the arrangement of components in FIG. 4. In various aspects a first communication including a resource as an attachment and including an attachment reference and/or second communication including the attachment reference may include a text-based message, an audio-based message, and/or an image based message, such as video. More particularly, the first communication and/or the second communication may include an email, an instant message, a short message service (SMS) message, a multimedia message service (MMS) message, a phone call, and/or a video call.

Application Ser. No. ______, (Docket No 0155) filed on 2010/07/______, entitled “Methods, Systems, and Program Products for Processing a Request for a Resource in a Communication” describes methods and systems for requesting a resource in a communication. In an aspect, attachment information identifying a resource to include as an attachment may be received in response to and/or otherwise based on a request received by first node 502 in a prior communication from second node 504.

An attachment reference generated by attachment manager component 408 and/or based on input received from a user of communications agent 403 may be based on the first communicant, the second communicant, the first node, the second node, a communications address in the first communication, a schema defining at least one of a format and vocabulary for the resource, a time, a location, a file name, a key for a database table, a tag, a keyword, another version of the resource, a task, a role of the resource in a task, and/or a state of the resource.

An attachment reference may be associated with a resource stored in a data store in execution environment 401 by associating the attachment reference with an address and/or other identifier of a location in the data store of some or all of the resource. The location may be identified by a file name in a hierarchical system of file folders. Other data stores, such as LDAP directories, identify locations based on identifiers from a hierarchical name space and are suitable for storing a resource received as an attachment in a communication. An identifier of a storage location of a resource may be generated from an attachment reference, include an attachment reference, identify an attachment reference, and/or otherwise be based on an attachment reference.

In an aspect, the second communication received by first node 502 may be received from the second node 504 as described above. In another aspect, a third node may receive the attachment reference in a communication with first node 502, second node 504, and/or another node that has communicated with one or both of first node 502 and second node 504. The second communication received by first node 502 may be received from the third node.

The second communication in the method illustrated in FIG. 2 may include a message in message portion 708b in FIG. 7 included as a reply to a first message in the first communication. In another aspect, the second communication may include a message portion that is empty and/or otherwise includes no message to present to the first communication represented by first node 502. In still another aspect, described above, the second communication may not be a reply and/or include a message that is a reply to the first communication and/or to a message included in the first communication. The second message may include a message in a message portion or may include a message portion with no message for the receiving communicant.

FIG. 7a illustrates that an attachment reference may be included in an attachment portion. Alternatively or additionally, an attachment reference may be included in a portion of a communication that is separate from the attachment portion including the attachment the attachment reference identifies. FIG. 7a and FIG. 7b illustrate that an attachment reference may be included in and/or otherwise identified in a header in a communication. The header may be defined to include and/or identify an attachment reference. Further FIG. 7b illustrates that an attachment reference may be identified based on a content type identifier, such as a MIME type identifier, defined to identify particular content as including an attachment reference. FIG. 7a and FIG. 7b both illustrate that an attachment reference may be included in a communication in a portion of the communication separate from a message portion of the communication.

An attachment reference may be detected in a communication based on its location in the communication. For example, an attachment reference portion of a communication may be specified to immediately follow the message portion of the communication. Alternatively or additionally, an attachment reference may be detected based on a keyword defined for identifying an attachment reference, such as the content-accessor entity header 704a in FIG. 7a and/or content-type entity header 706b in FIG. 7b.

In another aspect, first node 502 may send a third communication including the attachment reference included in the first communication, via network 506, for delivery to second node 504. First node 502 may send the third communication whether first node is the sender or the receiver of the first communication. The attachment reference is sent in the third communication for accessing, by the second communicant, the resource stored in an execution environment of second node 504.

In an aspect, a resource in a communication may be detected as a duplicate of a resource in another communication. In FIG. 4, attachment manager component 408 may detect and/or otherwise identify duplicate resources. For a node sending the communication, the attachment reference of the resource may be sent rather than sending the duplicate. Attachment manager component 408 may identify the duplicate to content manager component 406. Content manager component 406 may include and/or provide for including the attachment reference rather than the duplicate resource in the communication. The sender and/or receiver of a duplicate resource may store a single copy of the resource. When attachment manager component 408 detects a duplicate, attachment manager component 408 may combine two attachment references into one referencing a single copy of a resource. In another aspect, attachment manager component 408 may associate more than one attachment reference with a resource in order to avoid duplicate stored copies.

To the accomplishment of the foregoing and related ends, the descriptions and annexed drawings set forth certain illustrative aspects and implementations of the disclosure. These are indicative of but a few of the various ways in which one or more aspects of the disclosure may be employed. The other aspects, advantages, and novel features of the disclosure will become apparent from the detailed description included herein when considered in conjunction with the annexed drawings.

It should be understood that the various components illustrated in the various block diagrams represent logical components that are configured to perform the functionality described herein and may be implemented in software, hardware, or a combination of the two. Moreover, some or all of these logical components may be combined, some may be omitted altogether, and additional components may be added while still achieving the functionality described herein. Thus, the subject matter described herein may be embodied in many different variations, and all such variations are contemplated to be within the scope of what is claimed.

To facilitate an understanding of the subject matter described above, many aspects are described in terms of sequences of actions that may be performed by elements of a computer system. For example, it will be recognized that the various actions may be performed by specialized circuits or circuitry (e.g., discrete logic gates interconnected to perform a specialized function), by program instructions being executed by one or more instruction-processing units, or by a combination of both. The description herein of any sequence of actions is not intended to imply that the specific order described for performing that sequence must be followed.

Moreover, the methods described herein may be embodied in executable instructions stored in a computer-readable medium for use by or in connection with an instruction execution machine, system, apparatus, or device, such as a computer-based or processor-containing machine, system, apparatus, or device. As used here, a “computer-readable medium” may include one or more of any suitable media for storing the executable instructions of a computer program in one or more of an electronic, magnetic, optical, electromagnetic, and infrared form, such that the instruction execution machine, system, apparatus, or device may read (or fetch) the instructions from the computer-readable medium and execute the instructions for carrying out the described methods. A non-exhaustive list of conventional exemplary computer-readable media includes a portable computer diskette; a random access memory (RAM); a read only memory (ROM); an erasable programmable read only memory (EPROM or Flash memory); optical storage devices, including a portable compact disc (CD), a portable digital video disc (DVD), a high definition DVD (HD-DVD™), a Blu-ray™ disc; and the like.

Thus, the subject matter described herein may be embodied in many different forms, and all such forms are contemplated to be within the scope of what is claimed. It will be understood that various details may be changed without departing from the scope of the claimed subject matter. Furthermore, the foregoing description is for the purpose of illustration only, and not for the purpose of limitation, as the scope of protection sought is defined by the claims as set forth hereinafter.

All methods described herein may be performed in any order unless otherwise indicated herein explicitly or by context. The use of the terms “a” and “an” and “the” and similar referents in the context of the foregoing description and in the context of the following claims are to be construed to include the singular and the plural, unless otherwise indicated herein explicitly or clearly contradicted by context. The foregoing description is not to be interpreted as indicating that any non-claimed element is essential to the practice of the subject matter as claimed.

I claim:

1. A method for referencing an attachment in a communication, the method comprising:
communicating, by a first node representing a first communicant with a second node representing a second communicant, via a first communication including a resource as an attachment and including an attachment reference for referencing the resource in a second communication;
binding the attachment reference to the resource stored in a first execution environment of the first node;
receiving, by the first node, the attachment reference in the second communication; and
accessing, based on the binding, the stored resource, in response to receiving the attachment reference.

2. The method of claim 2 wherein at least one of the first communication and the second communication includes at least one of an email, an instant message, an short message service (SMS) message, a multimedia message service (MMS) message, a phone call, and a video call.

3. The method of claim 1 wherein communicating via the first communication includes receiving, by the first node, the first communication from the second node.

4. The method of claim 1 wherein communicating via the first communication comprises:
receiving attachment information identifying the first resource;
determining the attachment reference; and
sending, by the first node, the resource as an attachment and the attachment reference, to the second node, in the first communication.

5. The method of claim 4 wherein receiving the attachment information comprises:
presenting a navigation user interface element via an output device;
presenting a user-selectable representation of the resource in the navigation user interface element; and
receiving the attachment information, in response to a detected user input corresponding to the representation.

6. The method of claim 5 wherein presenting the user-selectable representation comprises:
receiving navigation information, corresponding to the navigation user interface element, from a user via an input device; and
in response to receiving the navigation information, presenting the user-selectable representation.

7. The method of claim 4 wherein the attachment information is received in response to a request, for the resource, received, by the first node, in a previous communication.

8. The method of claim 1 wherein the attachment reference is based on at least one of the first communicant, the second communicant, the first node, the second node, a communications address in the first communication, a schema defining at least one of a format and vocabulary for the resource, a time, a location, a file name, a key for a database table, a tag, a keyword, another version of the resource, a task, a role of the resource in a task, and a state of the resource.

9. The method of claim 1 wherein binding the attachment reference with the stored resource includes associating the attachment reference with a first location in a data store, in the first execution environment, for storing at least a portion of the resource.

10. The method of claim 1 wherein the second communication is received from the second node.

11. The method of claim 10 wherein the second communication includes a second message portion as a reply to a first message portion in the first communication.

12. The method of claim 11 wherein the second communication does not include a first message included in the first message portion in the first communication.

13. The method of claim 1 wherein the second communication includes a second message portion that is not a reply to a first message portion in the first communication.

14. The method of claim 1 wherein the resource is accessed automatically in response to at least one of receiving the second communication and receiving an indicator to present, via an output device, a second message in a second message portion of the second communication.

15. The method of claim 1 wherein the method further includes presenting a second message, included in a second message portion of the second communication, in a presentation space of a message user interface element and presenting the resource in a presentation space of a resource user interface element not included in the message UI element.

16. The method of claim 15 wherein presenting the resource comprises:
includes presenting a user interface control representing the resource along with the message user interface element; and
in response to a detected user input corresponding to the user interface control, presenting the resource user interface element including the resource.

17. The method of claim 1 further comprising:
presenting a representation of a second message in the second communication in a message navigation user interface element;
receiving selection information identifying the second message in response to a detected user input; and
presenting a selectable representation of the resource in an attachment user interface element in response to receiving the selection information.

18. The method of claim 1 further comprises:
determining that the resource is a duplicate of another resource received in another communication; and
at least one of storing a single instance of the resource in the first execution environment identified by the attachment reference and sending the other communication including the attachment reference rather than including the duplicate in the other communication as an attachment.

19. A system for referencing an attachment in a communication, the system comprising:
an execution environment including an instruction-processing unit configured to process an instruction included in at least one of a com-port component, a content handler component, a content manager component, and an attachment manager component;
the com-port component configured for communicating, by a first node representing a first communicant with a second node representing a second communicant, via a first communication including a resource as an attachment and including an attachment reference for referencing the resource in a second communication;
the content handler component configured for binding the attachment reference to the resource stored in a first execution environment of the first node;
the content manager component configured for receiving, by the first node, the attachment reference in the second communication; and
the attachment manager component configured for accessing, based on the binding, the stored resource, in response to receiving the attachment reference.

20. A computer-readable medium embodying a computer program, executable by a machine, for referencing an attachment in a communication, the computer program comprising executable instructions for:
communicating, by a first node representing a first communicant with a second node representing a second communicant, via a first communication including a resource as an attachment and including an attachment reference for referencing the resource in a second communication;
binding the attachment reference to the resource stored in a first execution environment of the first node;
receiving, by the first node, the attachment reference in the second communication; and
accessing, based on the binding, the stored resource, in response to receiving the attachment reference.
